(19) United States
(12) Patent Application Publication
(10) Pub. No.: US 2003/0110803 A1
(43) Pub. Date: Jun. 19, 2003

(54) Method of manufacturing glass substrate for magnetic disks, and glass substrate for magnetic disks

(75) Inventors: Yasuhiro Saito, Itami-shi (JP); Koji Okuhata, Yokkaichi-shi (JP); Kazuishi Mitani, Itami-shi (JP); Toshiaki Hashimoto, Yokkaichi-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: NIPPON SHEET GLASS CO., LTD., Osaka (JP)

(21) Appl. No.: 10/235,414

(22) Filed: Sep. 4, 2002

(30) Foreign Application Priority Data
Sep. 4, 2001 (JP) 2001-267199

(51) Int. Cl. C03C 15/00; B32B 1/00; D06N 7/04; B32B 17/00; B24B 1/00; B24B 7/19; B24B 7/30; C23F 1/00; B44C 1/22; C25F 3/00; C03C 25/68; C03B 13/00; C03B 18/02; B32B 3/00; B32B 27/14; B41J 2/47

(52) U.S. Cl. 65/30.14; 428/141; 428/410; 347/251; 451/41; 428/195; 428/694 SG; 216/97; 65/99.2; 65/99.6

(57) ABSTRACT

There is provided a method of manufacturing a glass substrate for magnetic disks, according to which circumferential direction texture can be formed without bringing about a drop in anisotropy, thus enabling coating with a magnetic recording layer having a large magnetic coercivity. In a texturing step, a tape is used while a diamond slurry is fed onto at least one main surface of a glass substrate member that has been processed into a substantially circular shape, thus forming a linear texture in a circumferential direction on the at least one main surface. In a chemical strengthening step, the mechanical strength of the glass substrate member is chemically strengthened to a level required of the glass substrate for magnetic disks. The texturing step is carried out after the chemical strengthening step.

### BACKGROUND OF THE INVENTION

1. Field of the Invention

The present invention relates to a method of manufacturing a glass substrate for magnetic disks, and a glass substrate for magnetic disks manufactured using the method. More specifically, the present invention relates to a method of manufacturing a glass substrate for magnetic disks for obtaining a magnetic disk that enables the flying height of a magnetic head to be reduced and has high reliability such that loss or decay of magnetically recorded information does not occur even upon prolonged usage at a high rotational speed, and a glass substrate for magnetic disks manufactured using the method.

2. Description of the Related Art

In recent years, there has been remarkable progress in the digitalization of information, and various types of information recording apparatus for storing digital information have been developed. There have been very rapid improvements and advances in these information recording apparatuses, and both the information storage capacity and the playback speed of recorded information have been increasing at a rate of several tens of percent per year. Magnetic disk apparatuses are currently the most widely used of these information recording apparatuses, and the rate of improvement thereof has been even higher than with other information recording apparatuses.

Amid such a situation, there are demands for magnetic disk apparatuses to have magnetic recording media (magnetic disks) that can cope with increased recording density. To meet these demands, it has become that substrates for magnetic disks are also required to have high flatness, smoothness and rigidity. Consequently, although aluminum substrates were the most commonly used substrates for magnetic disks in the past, recently glass substrates, which can easily be ground and polished, have become more and more commonly used.

In the case of an aluminum substrate, in general an Ni-based alloy layer comprised predominantly of NiP or the like is formed on the aluminum substrate, and then anisotropic texture (circumferential direction texture) is formed in the circumferential direction by mechanical means such as grinding. The magnetic disk is then generally manufactured by forming a Cr-based foundation layer and then a Co-based magnetic recording layer on the texture. In the case of such a magnetic disk, an oriented medium having magnetic anisotropy in which the magnetic coercivity is raised in the circumferential direction is formed.

In the case of a glass substrate, on the other hand, the magnetic recording layer is formed on either a smooth surface or else an isotropically textured surface formed by etching or sputtering, and accordingly an isotropic medium having no magnetic anisotropy with respect to the circumferential direction is thus formed.

However, there is a great problem when increasing the recording density of digital information, i.e. when making the magnetic recording size smaller, in that magnetization reversal becomes more prone to occur at normal temperature, and hence written signals may be lost or decay, and in the worst cases it may become impossible to carry out magnetic recording. Regarding this problem, the margin for loss or decay with regard to changes in the recorded information over time is greater for an oriented medium than an isotropic medium (H. Akimoto et al., J. Magn. Magn. Mater., 193 (1999), 240-244). It is thus possible to secure higher reliability with a magnetic disk apparatus manufactured using an oriented medium than a magnetic disk apparatus manufactured using an isotropic medium.

Due to this state of affairs, with glass substrates, as with aluminum substrates, there have been cases of depositing NiP on a glass substrate and then forming texture in the circumferential direction of the glass substrate. If a glass substrate on which texture has been formed in the circumferential direction is used, then through orientation being formed on the magnetic recording medium, not only are the magnetic properties improved, but also the flight stability of the magnetic head of the information recording apparatus is improved. However, there is minute waviness on the main surfaces of the glass substrate before the texturing, this minute waviness being formed through the smoothing polishing that is carried out. The minute waviness has periodicity in a direction unrelated to the circumferential direction, and hence causes wobbling of the magnetic head, whereby the flying stability cannot be improved sufficiently. Consequently, if the minute waviness is reduced, then due to synergism with the head flight stabilizing effect of the texture, the flight stability can be improved greatly even in the case of a low flying height.

However, there has been a problem that during the process of forming texture mechanically on NiP, foreign matter is prone to arising, and this leads to the yield when manufacturing media dropping, and thus to the cost rising. Studies have thus begun to be carried out into techniques for forming anisotropic texture directly onto glass substrate surfaces, and recently a method has been proposed in which cerium oxide, which has a high polishing ability on glass, is mixed into a diamond slurry (Japanese Laid-open Patent Publication (Kokai) No. 2001-101656). Moreover, a technique has been proposed in which a slurry containing a solution having hydroxyl groups such as a potassium hydroxide aqueous solution or a sodium hydroxide aqueous solution is used, thus adding a chemical action to the mechanical processing force (Japanese Laid-open Patent Publication (Kokai) No. 2000-301441, Japanese Laid-open Patent Publication (Kokai) No. 2001-9694). According to these techniques, a fine texture can be formed on the surfaces of glass substrates, which are harder than aluminum substrates.

However, with a substrate for magnetic disks, to obtain the required mechanical strength and degree of cleanliness, chemical strengthening treatment and also various types of washing using acidic and/or alkaline aqueous solutions are carried out, but the circumferential direction texture is extremely fine, and hence the shape thereof is easily changed by the mechanical/chemical action during these chemical strengthening and washing steps. Consequently, in conventional processes of manufacturing a substrate that is textured in the circumferential direction, it has not been possible to obtain circumferential direction texture that is controlled sufficiently precisely to improve the magnetic properties as described above, while still obtaining the mechanical strength and cleanliness required of a substrate for magnetic disks.

Moreover, with substrates for magnetic disks, to secure the required smoothness, smoothing polishing using a slurry containing cerium oxide abrasive grains is carried out before the texturing. Regarding the method of carrying out the smoothing polishing, it is common to use a both-surface polishing machine in which a plurality of the glass substrates are held in each of a plurality of carriers sandwiched between an upper plate and a lower plate each of which has a suede pad bonded thereto, and polishing is carried out while the carriers are made to both revolve around the central axis through the upper and lower plates and rotate on their own axes. In this case, sinew-like undulations called polishing marks and minute waviness are formed in random fashion on the glass surfaces. Moreover, because a glass substrate is harder than an aluminum substrate, with conventional texturing the grinding amount of the glass surfaces (i.e. the amount of glass removed from the glass surfaces in the thickness direction of the glass substrate) is very low at only about a few nm. The shape of the texture is thus greatly affected by the surface roughness after the smoothing polishing, and in particular there has been a problem that the fine circumferential direction texture lines are divided into parts by the sinew-like polishing marks and minute waviness that have been formed in random directions, and hence the anisotropy drops.

### SUMMARY OF THE INVENTION

It is a first object of the present invention to provide a glass substrate for magnetic disks and a manufacturing method thereof, according to which circumferential direction texture can be formed without bringing about a drop in anisotropy, thus enabling coating with a magnetic recording layer having a large magnetic coercivity.

It is a second object of the present invention to provide a glass substrate for magnetic disks and a manufacturing method thereof, according to which abnormal projections on the recording surfaces of a magnetic disk manufactured using the glass substrate are eliminated as much as possible, and hence the probability of occurrence of head crashes in which damage occurs through the magnetic recording head of a magnetic disk apparatus colliding with the magnetic disk is reduced.

It is a third object of the present invention to provide a glass substrate for magnetic disks and a manufacturing method thereof, according to which the number of ridge-shaped texture lines formed in the circumferential direction of the glass substrate that have an abnormal height is reduced, and hence the stability of a magnetic recording head during low flight is improved, i.e. wobbling of the magnetic recording head during low flight is reduced.

To attain the first to third objects described above, in a first aspect of the present invention, there is a method of manufacturing a glass substrate for magnetic disks, comprising a texturing step of using a tape while feeding a diamond slurry onto at least one main surface of a glass substrate member that has been processed into a substantially circular shape, thus forming a linear texture in a circumferential direction on the at least one main surface, and a chemical strengthening step of chemically strengthening a mechanical strength of the glass substrate member to a level required of the glass substrate for magnetic disks, wherein the texturing step is carried out after the chemical strengthening step.

In the first aspect, preferably, the method of manufacturing a glass substrate for magnetic disks further comprises, following the texturing step, a tape washing step of rubbing the at least one main surface of the glass substrate member in the circumferential direction using the tape while feeding at least one of a neutral aqueous solution and an alkaline aqueous solution onto the at least one main surface, and a scrub washing step of rubbing the at least one main surface using at least one scrubbing member while feeding at least one of a neutral aqueous solution and an alkaline aqueous solution onto the at least one main surface.

In the first aspect, preferably, in the scrub washing step, the rubbing of the at least one main surface of the glass substrate member is carried out in a direction crossing the circumferential direction.

In the first aspect, preferably, the method of manufacturing a glass substrate for magnetic disks further comprises, following the scrub washing step, an ultrasonic washing step of washing the at least one main surface of the glass substrate member by applying ultrasound to the at least one main surface while feeding at least one of a neutral aqueous solution and an alkaline aqueous solution onto the at least one main surface.

In the first aspect, preferably, the at least one scrubbing member comprises a sponge having an Asker C hardness of not less than 40.

In the first aspect, preferably, the method of manufacturing a glass substrate for magnetic disks further comprises, before the texturing step, a smoothing polishing step of polishing the at least one main surface of the glass substrate member using at least one polishing member to make the at least one main surface smooth, wherein the smoothing polishing step makes the at least one main surface have an average roughness Ra of not more than 0.35 nm as measured using an atomic force microscope.

In the first aspect, preferably, the method of manufacturing a glass substrate for magnetic disks further comprises, before the texturing step, a smoothing polishing step of polishing the at least one main surface of the glass substrate member using at least one polishing member to make the at least one main surface smooth, wherein the smoothing polishing step makes the at least one main surface have an average roughness Ra of not more than 0.25 nm as measured using an atomic force microscope.

In the first aspect, preferably, the smoothing polishing step comprises polishing the at least one main surface of the glass substrate member while feeding a slurry containing cerium oxide onto the at least one main surface, and then polishing the at least one main surface while feeding colloidal silica onto the at least one main surface.

In the first aspect, preferably, the smoothing polishing step makes the at least one main surface of the glass substrate member having a waviness of a wavelength in a range of 0.2 to 1.4 mm have an average roughness Ra of not more than 0.25 nm as measured using a non-contact optical interferometer.

In the first aspect, preferably, the at least one polishing member comprises a suede pad having an Asker C hardness of not less than 73.

To attain the second and third objects described above, in a second aspect of the present invention, there is provided a method of manufacturing a glass substrate for magnetic disks a method of manufacturing a glass substrate for magnetic disks, comprising a texturing step of using a tape while feeding a diamond slurry onto at least one main surface of a glass substrate member that has been processed into a substantially circular shape, thus forming a linear texture on the at least one main surface, wherein in the texturing step the texture is formed in a circumferential direction of the at least one main surface of the glass substrate member.

In the second aspect, preferably, the method of manufacturing a glass substrate for magnetic disks further comprises, following the texturing step, a tape washing step of rubbing the at least one main surface of the glass substrate member in the circumferential direction using the tape while feeding at least one of a neutral aqueous solution and an alkaline aqueous solution onto the at least one main surface, and a scrub washing step of rubbing the at least one main surface of the glass substrate member in a direction crossing the circumferential direction using at least one scrubbing member while feeding at least one of a neutral aqueous solution and an alkaline aqueous solution onto the at least one main surface.

In the second aspect, preferably, the method of manufacturing a glass substrate for magnetic disks further comprises, following the scrub washing step, an ultrasonic washing step of washing the at least one main surface of the glass substrate member by applying ultrasound to the at least one main surface while feeding at least one of a neutral aqueous solution and an alkaline aqueous solution onto the at least one main surface.

In the second aspect, preferably, the at least one scrubbing member comprises a sponge having an Asker C hardness of not less than 40.

In the second aspect, preferably, the method of manufacturing a glass substrate for magnetic disks further comprises, before the texturing step, a smoothing polishing step of polishing the at least one main surface of the glass substrate member using at least one polishing member to make the at least one main surface smooth, wherein the smoothing polishing step makes the at least one main surface have an average roughness Ra of not more than 0.35 nm as measured using an atomic force microscope.

In the second aspect, preferably, the method of manufacturing a glass substrate for magnetic disks further comprises, before the texturing step, a smoothing polishing step of polishing the at least one main surface of the glass substrate member using at least one polishing member to make the at least one main surface smooth, wherein the smoothing polishing step makes the at least one main surface have an average roughness Ra of not more than 0.25 nm as measured using an atomic force microscope.

In the second aspect, preferably, the smoothing polishing step comprises polishing the at least one main surface of the glass substrate member while feeding a slurry containing cerium oxide onto the at least one main surface, and then polishing the at least one main surface while feeding colloidal silica onto the at least one main surface.

In the second aspect, preferably, the smoothing polishing step makes the at least one main surface of the glass substrate member having a waviness of a wavelength in a range of 0.2 to 1.4 mm have an average roughness Ra of not more than 0.25 nm as measured using a non-contact optical interferometer.

In the second aspect, preferably, the at least one polishing member comprises a suede pad having an Asker C hardness of not less than 73.

To attain the first to third objects described above, in a third aspect of the present invention, there is provided a glass substrate for magnetic disks a glass substrate for magnetic disks, manufactured using a method of manufacturing a glass substrate for magnetic disks as claimed in any of claims 1 through 19, comprising a linear texture formed on at least one main surface of the glass substrate, wherein the linear texture has a line density in a range of 5000 to 40000 lines/mm as measured using an atomic force microscope, an average roughness Ra in a range of 0.2 to 0.9 nm, and a value Rmax obtained by subtracting a minimum height of the texture from a maximum height of the texture of not more than 10 nm.

In the third aspect, preferably, the linear texture has an average line length of not less than 0.3 mm.

According to the first aspect of the present invention, the texturing step is carried out after the chemical strengthening step of chemically strengthening the mechanical strength of the glass substrate member to a level required of a glass substrate for magnetic disks. As a result, the shape of the texture formed through the texturing step cannot be changed through the chemical strengthening step. A glass substrate for magnetic disks having a large magnetic coercivity can thus be manufactured without bringing about a drop in anisotropy.

According to the first aspect of the present invention, following the texturing step, a tape washing step of rubbing the at least one main surface of the glass substrate member in the circumferential direction using the tape while feeding at least one of a neutral aqueous solution and an alkaline aqueous solution onto the at least one main surface, and a scrub washing step of rubbing the at least one main surface using at least one scrubbing member while feeding at least one of a neutral aqueous solution and an alkaline aqueous solution onto the at least one main surface, are preferably carried out. As a result, washing can be carried out such that the change in the texture shape is minimized, and moreover ridge-shaped abnormal projections formed through the texturing can be removed efficiently. A glass substrate for magnetic disks can thus be manufactured according to which the probability of occurrence of head crashes in which damage occurs through the magnetic head of a magnetic disk apparatus colliding with a magnetic disk manufactured using the glass substrate is low, and moreover there is little wobbling of the magnetic head during low flight.

According to the first and second aspects of the present invention, following the texturing step, a tape washing step of rubbing the at least one main surface of the glass substrate member in the circumferential direction using the tape while feeding at least one of a neutral aqueous solution and an alkaline aqueous solution onto the at least one main surface, and a scrub washing step of rubbing the at least one main surface in a direction crossing the circumferential direction using at least one scrubbing member while feeding at least one of a neutral aqueous solution and an alkaline aqueous solution onto the at least one main surface, are preferably carried out. As a result, washing can be carried out such that the change in the texture shape is minimized, and moreover ridge-shaped abnormal projections formed through the texturing can be removed yet more efficiently. A glass substrate for magnetic disks can thus be manufactured according to which the probability of occurrence of head crashes in which damage occurs through the magnetic head of a magnetic disk apparatus colliding with a magnetic disk manufactured using the glass substrate is yet lower, and moreover there is yet less wobbling of the magnetic head during low flight.

According to the first and second aspects of the present invention, following the scrub washing step, an ultrasonic washing step of washing the at least one main surface of the glass substrate member by applying ultrasound to the at least one main surface while feeding at least one of a neutral aqueous solution and an alkaline aqueous solution onto the at least one main surface is preferably carried out. As a result, general foreign matter can be completely removed. Better washing can thus be carried out.

According to the first and second aspects of the present invention, the at least one scrubbing member is preferably a sponge having an Asker C hardness of not less than 40. As a result, the efficiency of removal of ridge-shaped abnormal projections can be reliably improved.

According to the first and second forms of the present invention, before the texturing step, a smoothing polishing step of polishing the at least one main surface of the glass substrate member using at least one polishing member to make the at least one main surface smooth is preferably carried out, wherein the smoothing polishing step makes the at least one main surface have an average roughness Ra according to JIS B0601 of not more than 0.35 nm as measured using an atomic force microscope (AFM). As a result, the line density of the linear texture becomes higher, and the length of the texture lines becomes longer, and hence the magnetic properties can be improved.

According to the first and second aspects of the present invention, before the texturing step, a smoothing polishing step of polishing the at least one main surface using at least one polishing member to make the at least one main surface of the glass substrate member smooth is preferably carried out, wherein the smoothing polishing step makes the at least one main surface have an average roughness Ra of not more than 0.25 nm as measured using an atomic force microscope. As a result, the line density of the texture becomes yet higher, and the length of the texture lines becomes yet longer, and hence the magnetic properties can be further improved.

According to the first and second aspects of the present invention, the smoothing polishing step preferably comprises polishing the at least one main surface of the glass substrate member while feeding a slurry containing cerium oxide onto the at least one main surface, and then polishing the at least one main surface while feeding colloidal silica onto the at least one main surface. As a result, the average roughness Ra can be made to be not more than 0.2 nm. The line density of the texture after the texturing step thus becomes yet higher. The magnetic properties can thus be yet further improved.

According to the first and second aspects of the present invention, the smoothing polishing step preferably makes the at least one main surface of the glass substrate member have an average roughness value Ra of waviness of wavelength in a range of 0.2 to 1.4 mm of not more than 0.25 nm as measured using a non-contact optical interferometer. As a result, the head flight stability can be improved.

According to the first and second aspects of the present invention, the at least one polishing member is preferably a suede pad having an Asker C hardness of not less than 73. As a result, the waviness can be made yet smaller in size.

According to the third aspect of the present invention, the linear texture formed on the at least one main surface of the glass substrate has a line density in a range of 5000 to 40000 lines/mm as measured using an atomic force microscope, Ra in a range of 0.2 to 0.9 nm, and a value Rmax obtained by subtracting the minimum height of the texture from the maximum height of the texture of not more than 10 nm. As a result, a magnetic disk can be manufactured according to which the magnetic coercivity is large, the probability of occurrence of head crashes in which damage occurs through the magnetic head of a magnetic disk apparatus colliding with the magnetic disk is low, and there is little wobbling of the magnetic head during low flight.

According to the third aspect of the present invention, the linear texture has an average line length of not less than 0.3 mm. As a result, a good anisotropy can be obtained, and hence the orientation property of the magnetic film(s) on the magnetic disk can be improved.

The above and other objects, features and advantages of the invention will become more apparent from the following detailed description taken in conjunction with the accompanying drawings.

### BRIEF DESCRIPTION OF THE DRAWINGS

FIG. 1 is a flowchart showing steps in a method of manufacturing a glass substrate for magnetic disks according to an embodiment of the present invention; and

FIG. 2 is a schematic view illustrating the texturing in the method of manufacturing a glass substrate for magnetic disks according to the embodiment of the present invention.

### DETAILED DESCRIPTION OF THE PREFERRED EMBODIMENTS

A detailed description will now be given of a method of manufacturing a glass substrate for magnetic disks according to an embodiment of the present invention, with reference to the drawings.

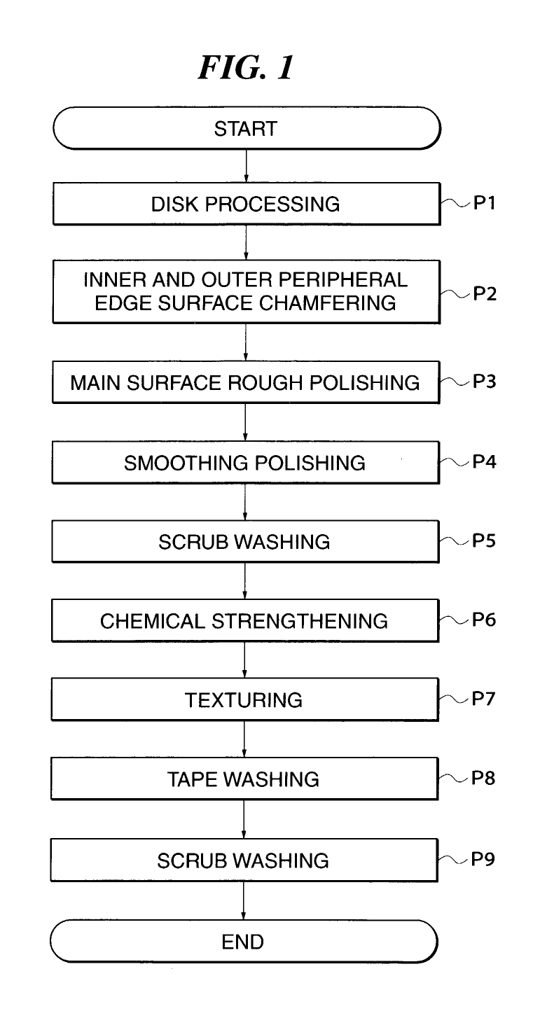

FIG. 1 is a flowchart showing steps in a method of manufacturing a glass substrate for magnetic disks according to an embodiment of the present invention.

A glass plate is formed before a first step, a disk processing step P1. There are no particular limitations on the method of forming the glass plate; any of various methods can be used, for example a float process, a down draw method, a redraw method, or a pressing method.

There are no particular limitations on the type of the glass. Examples include a soda lime glass having silicon dioxide, one or more alkali metal oxides and one or more alkaline earth metal oxides as principal components thereof, an aluminosilicate glass having silicon dioxide, aluminum oxide and one or more alkali metal oxides as principal components thereof, and a borosilicate glass having silicon dioxide and boron oxide as principal components thereof, and also crystallized glasses such as an Li₂O—SiO₂ glass having lithium oxide and silicon dioxide as principal components thereof, an Li₂O—Al₂O₃—SiO₂ glass having lithium oxide, silicon dioxide and aluminum oxide as principal components thereof, and an RO—Al₂O₃—SiO₂ glass (wherein RO is magnesium oxide MgO, calcium oxide CaO, strontium oxide SrO, barium oxide BaO, zinc oxide ZnO, nickel oxide NiO, manganese oxide MnO etc.) having one or more alkaline earth metal oxides or the like, aluminum oxide and silicon dioxide as principal components thereof. Aluminum oxide, alkali metal oxides and alkaline earth metal oxides are components that readily dissolve in acidic aqueous solutions, and hence including moderate amounts of these as components of the glass makes etching relatively easy. An example of the glass is an aluminosilicate glass having the undermentioned composition. Note that here and hereinafter “%” means “mol percent (mol %)” unless otherwise stated.

Silicon dioxide (SiO₂): 55 to 70%,

Aluminum oxide (Al₂O₃): 1 to 12.5%,

Lithium oxide (Li₂O): 5 to 20%,

Sodium oxide (Na₂O): 0 to 14%,

Potassium oxide (K₂O): 0 to 3,

Magnesium oxide (MgO): 0 to 8,

Calcium oxide (CaO): 0 to 10,

Strontium oxide (SrO): 0 to 6%,

Barium oxide (BaO): 0 to 2%,

Titanium dioxide (TiO₂): 0 to 8%, and

Zirconium oxide (ZrO₂): 0 to 4%.

The glass having a composition as described above is formed into a plate shape, and in the disk processing step P1 the resulting glass plate is processed into a glass substrate member having a donut shape using a hard metal or diamond cutter. There are no particular limitations on the method of processing the glass plate into the donut shape. For example, it is possible to first cut only the outer periphery to the desired outside diameter, and then cut the inner periphery to the desired inside diameter using a cylindrical diamond grindstone, or it is also possible to press the glass plate into a disk shape having the desired outside diameter, and then bore a hole to the desired inside diameter using a diamond grindstone.

Next, in an inner and outer peripheral edge surface chamfering step P2, the inner and outer peripheral edge surfaces of the donut-shaped glass substrate member that has been prepared as described above are ground to accurately make the inside and outside diameters be the desired product dimensions. There are no particular limitations on the grinding method. Generally, the grinding is carried out using grindstones having diamond abrasive grains attached thereto. The grindstones can be manufactured to have a shape such that, during the grinding, the inner and outer peripheral edge surfaces of the glass substrate are also chamfered, thus giving the glass substrate a predetermined product shape. The grinding and chamfering of the inner and outer peripheral edge surfaces may be carried out either simultaneously or separately. After the inner and outer peripheral edge surface chamfering step P2, the edge surfaces and the chamfered surfaces may be polished using a cerium oxide polishing agent to make the edge surfaces and the chamfered surfaces smooth.

Next, in a main surface rough polishing step P3, rough polishing may be carried out if necessary using alumina abrasive grains or the like, to adjust the thickness of the glass substrate member and remove defects from the main surfaces of the glass substrate member. Moreover, such rough polishing may also be carried out before the inner and outer peripheral edge surface chamfering step P2, or may be carried out in two stages, one before the inner and outer peripheral edge surface chamfering step P2, and one after the inner and outer peripheral edge surface chamfering step P2.

Next, to secure the flatness required of the substrate for magnetic disks, it is preferable to polish the main surfaces of the glass substrate member to make them smooth through a smoothing polishing step P4. There are no particular limitations on the type of the polishing agent used in this step, but generally a cerium oxide-based polishing agent, which has a high polishing ability on glass, is used. Moreover, there are no particular limitations on the particle size of the polishing agent, but to obtain both a sufficient smoothness of the main surfaces of the glass substrate member after the polishing and a sufficient polishing rate from the standpoint of productivity, generally a polishing agent having a mean particle diameter in a range of about 0.1 to 3 μm is used. There are also no particular limitations on the polishing method, but if a both-surface polishing machine having polishing members such as artificial leather pads, suede pads, or pads having an ester type or ether type resin as the outermost surface thereof bonded onto each of an upper plate and a lower plate is used, then both main surfaces of the glass substrate member can be simultaneously polished precisely at low cost. Moreover, to obtain both a sufficient smoothness and a sufficient polishing rate, it is also possible to carry out the polishing in two stages, where the polishing agent, the polishing rate and so on differ between the stages.

The smoothing polishing step should be carried out such that the main surface of the glass substrate member has an average roughness Ra of not more than 0.25 nm as measured using an atomic force microscope (AFM). As a result, the line density of the linear texture becomes higher, and the length of the texture lines becomes longer, and hence the magnetic properties can be improved.

Further, the smoothing polishing step should be carried out such that the main surface of the glass substrate member having a waviness of a wavelength in a range of 0.2 to 1.4 mm has an average roughness Ra of not more than 0.25 nm as measured using a non-contact optical interferometer. As a result, the flight stability can be improved greatly even in the case of a low flying height.

There are no particular limitations on the polishing pads used in the smoothing polishing step P4, but it is preferable to use artificial leather pads, suede pads or the like having an Asker C hardness as stipulated in Standard SRIS 0101 of the Society of Rubber Industry, Japan of not less than 70, since then the waviness generated will be smaller in size.

After carrying out polishing using a cerium oxide-based polishing agent as described above, it is possible to polish again using colloidal silica, thus further improving the smoothness. As a result, the average roughness Ra of the main surface of the glass substrate member can be not more than 0.2 nm and hence the texture line density can be made higher. There are no particular limitations on the particle diameter of the colloidal silica, but generally silica particles having a mean particle diameter in a range of about 10 to 100 nm are used. Moreover, there are no particular limitations on the polishing method; any method that enables the required smoothness to be obtained can be used. For example, a both-surface polishing machine as described above may be used, or a one-surface polishing machine that polishes one surface of each glass substrate member at a time may be used. Moreover, batch processing in which a plurality of glass substrate members are polished simultaneously may be carried out, or single wafer processing in which the glass substrate members are polished one at a time may be carried out.

After the smoothing polishing step P4 described above, in a scrub washing step P5, washing is carried out to remove slurry (polishing agent) and so on remaining on the main surfaces of the glass substrate member. There are no particular limitations on the washing method, but since any remaining polishing agent will become firmly fixed to the main surfaces and thus difficult to remove during a subsequent chemical strengthening step P6, it is preferable to not merely carry out simple washing using water and a detergent, but rather remove attached material such as residual polishing agent mechanically by rubbing the main surfaces of the glass substrate member with a soft resin or the like (scrub member), and carry out washing thoroughly using a suitable combination of an acidic aqueous solution or an alkaline aqueous solution and pure water while also applying ultrasound.

Next, in the chemical strengthening step P6, chemical strengthening treatment is carried out to improve the reliability of the glass substrate member under mechanical shock received during handling, heat shock received during formation of films such as magnetic films on the glass substrate member surfaces, and prolonged usage after the glass substrate is incorporated into a hard disk drive as a magnetic disk. There are no particular limitations on the method of carrying out the chemical strengthening treatment. The chemical strengthening treatment can be carried out, for example, by immersing the glass substrate member for several hours in a mixed salt of potassium nitrate and sodium nitrate that has been melted by heating to a temperature of about 400° C. As a result, down to a depth of about 100 μm from the glass substrate member surfaces, ion exchange takes place between lithium ions and sodium ions in the glass components and potassium ions in the strengthening salt, thus enabling the mechanical strength required of the substrate for magnetic disks to be obtained. Afterwards, the glass substrate is immersed for about 1 hour in warm water at 50 to 80° C., thus dissolving off strengthening salt remaining on the glass substrate member surfaces.

After the chemical strengthening step P6, a texturing step P7 is carried out in which the glass substrate member is subjected to texturing. In the texturing, circular texture lines are formed in the circumferential direction of the glass substrate member (circumferential direction texturing). It is preferable to carry out the texturing after the chemical strengthening step P6, but the texturing may also be carried out before the chemical strengthening step P6. Moreover, the texturing may also be carried out after the scrub washing step P5, with the chemical strengthening treatment not being carried out. It should be noted, however, that if the texturing is carried out before the chemical strengthening treatment, then the shape of the texture may be changed through the chemical strengthening treatment; by carrying out the texturing after the chemical strengthening treatment, the ability to control the texture shape can thus be improved, and moreover a texture having a high line density and a long line length can be formed. Moreover, between the chemical strengthening step P6 and the texturing step P7, ultrasonic washing, brush scrub washing or the like using an acidic aqueous solution or an alkaline aqueous solution may be carried out as necessary to remove soiling that has become attached to the glass substrate member surfaces during the chemical strengthening step P6.

The fact that the texture shape changes between before and after chemical strengthening treatment was first revealed through experiments carried out by the present inventors; some of the details are unclear, but it is conjectured that the reason for the texture shape changing is as follows. When a linear texture (i.e. a texture comprised of lines) is formed on the surfaces of a glass substrate member using a diamond abrasive grain slurry, mechanical stress is applied to the glass substrate member surfaces by the hard diamonds, and hence residual strain is formed in the surfaces. At places where this residual strain is formed (compressed layers), the glass structure is compressed and hence the density becomes higher than in other, normal places. In particular, the residual strain is severe in the troughs of the linear texture, and hence the density is high here. If a glass substrate member on which such texture has been formed is subjected to chemical strengthening treatment, then the strain in the compressed layers is relaxed through the heat in the chemical strengthening treatment, and the volume in these places expands more than in other places. As a result, in the case that the texture is formed before the chemical strengthening treatment, expansion occurs at the troughs of the texture during the chemical strengthening treatment, and hence the height difference between the troughs and the ridges of the texture drops, i.e. the texture shape is lost to some extent.

The texturing can be carried out on the main surfaces of the glass substrate member by using a diamond slurry and a tape. There are no particular limitations on the apparatus used to carry out the texturing, but a so-called texturing machine, which is used in the texturing of aluminum substrates and the like, can be used.

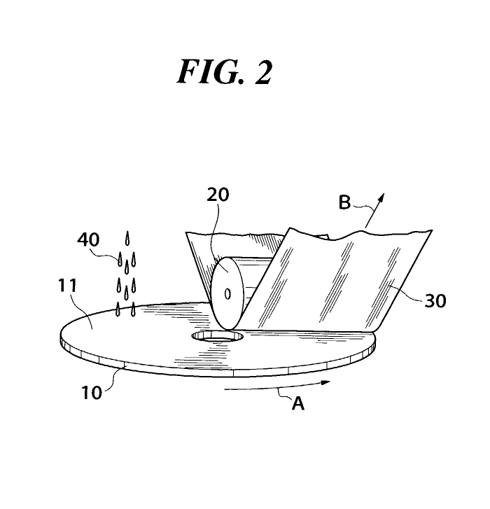

FIG. 2 is a schematic view illustrating the texturing.

In FIG. 2, a roller 20 is disposed on the glass substrate member 10. The axis of rotation of the roller 20 is made to be the same as the radial direction of the glass substrate member 10. A tape 30 passes between the glass substrate member 10 and the roller 20. The tape 30 is pushed against a main surface 11 of the glass substrate member 10 by the roller 20.

During the texturing, a slurry 40 is fed onto the main surface 11 from above, and moreover the glass substrate member 10 is rotated in the direction of the arrow A, and the tape 30 is pulled in the direction of the arrow B. As a result, a texture is formed on the main surface 11.

There are no particular limitations on the material of the tape 30 used in the texturing; any material used in this kind of processing can be used, for example polyethylene fibers. The slurry 40 contains diamond abrasive grains. There are no particular limitations on the particle diameter or shape of the diamond abrasive grains; these can be selected as appropriate in accordance with the required texture line density. Moreover, there are no particular limitations on the crystalline form of the diamond abrasive grains; either monocrystalline or polycrystalline ones can be used. Moreover, to improve the grinding ability, abrasive grains of cerium oxide, manganese oxide or the like may be added in addition to the diamond abrasive grains, and an alkali may also be added.

Regarding the particle diameter of the diamond abrasive grains, the mean particle diameter (D50) is preferably in a range of 0.09 to 0.3 μm. If the mean particle diameter is less than 0.09 μm, then the texture forming ability will be low. Specifically, the grinding rate will drop, leading to an increase in the cost of the texturing, which is undesirable. From this viewpoint, it is preferable for the mean particle diameter of the diamond abrasive grains in the diamond slurry to be made to be not less than 0.09 μm, preferably not less than 0.15 μm.

On the other hand, from the viewpoint of forming a large number of small ridges per unit distance, i.e. making the texture line density high, in the radial direction of the glass substrate member, the mean particle diameter of the diamond abrasive grains is preferably made to be not more than 0.3 μm, more preferably not more than 0.25 μm.

There are also no particular limitations on the solution in which the diamond abrasive grains are dispersed. Furthermore, a surfactant may be added to improve the dispersibility of the diamond abrasive grains.

Moreover, there are no particular limitations on the conditions under which the texturing is carried out; the conditions can be selected in accordance with the desired texture shape, line density and line length. Examples are the conditions shown as “a” and “b” in Table 1.

TABLE 1

| | a | b |
|---|---|---|
| Tape Tension (lbs) | 5 | 5 |
| Tape Speed (inch/min) | 3 | 3 |
| Roller Pushing Pressure (lbs) | 7 | 7 |
| Spindle Speed (inch/min) | 300 | 300 |
| Tape Material | TMT-57 (TORAY) | TMT-57 (TORAY) |
| Slurry Particle Size (μm) | 0.2 | 0.1 |
| Slurry Feeding Rate (ml/min) | 20 | 20 |

After the texturing has been carried out, thorough washing is carried out to remove foreign matter that has arisen during the texturing step such as diamond slurry. There are no particular limitations on the washing method, but if the following methods are used, then a high degree of cleanliness can be obtained with virtually no change in the texture shape. First, in a tape washing step P8, tape washing is carried out in which a tape-shaped film is pushed against the main surface of the glass substrate member, thus rubbing the main surface in the circumferential direction, while feeding at least one of a neutral aqueous solution and an alkaline aqueous solution as a washing solution onto the main surface. As a result, diamond abrasive grains that have become firmly attached to the main surface of the glass substrate member can be removed efficiently through the physical washing ability of the tape, without damaging the texture.

The reason for carrying out the rubbing in the circumferential direction is to minimize the change in the texture shape due to the washing. If the rubbing were carried out in a direction other than the circumferential direction, then there would be a risk of the diamond slurry, a large amount of which have become attached to the main surface of the glass substrate member during the texturing, destroying the texture shape.

The tape washing can be carried out using the same apparatus as that used in the texturing. There are no particular limitations on the conditions under which the tape washing is carried out; the tape washing can, for example, be carried out under the conditions shown in Table 2.

TABLE 2

| | |
|---|---|
| Tape Tension (lbs) | 2 |
| Tape Speed (inch/min) | 3 |
| Roller Pushing Pressure (lbs) | 2 |
| Spindle Speed (inch/min) | 300 |
| Tape Material | SPD 2501-NF |
| Washing Solution Feeding Rate (ml/min) | 20 |

After the tape washing has been carried out, in a scrub washing step P9, scrub washing is carried out in a direction crossing the circumferential direction of the glass substrate member, whereby ridge-shaped abnormal projections can be removed efficiently. There are no particular limitations on the material of the sponges used in the scrub washing, but the ridge-shaped abnormal projections can be removed efficiently by using hard sponges having an Asker C hardness of at least 40. There are no particular limitations on the scrubbing conditions such as the pressure applied to the glass substrate member surfaces by the scrubbing members and the rotational speed of the glass substrate member during the scrubbing; these conditions should be selected in accordance with the extent of residual soiling. The washing solution fed onto the main surfaces of the glass substrate member during the scrub washing is at least one of a neutral aqueous solution and an alkaline aqueous solution.

The reason for carrying out the scrub washing in a direction crossing the circumferential direction of the glass substrate member is to efficiently remove ridge-shaped abnormal projections that have been formed through the texturing. Here, “ridge-shaped abnormal projection” means a projection that is formed in a linear shape and is abnormally higher than the average height in the vicinity thereof. If such abnormal projections remain, then there will be an adverse effect on the magnetic head flight stability. Such ridge-shaped abnormal projections are formed in the circumferential direction through the mechanical processing using the diamond abrasive grains, and can thus be removed efficiently by scrubbing in a direction crossing the circumferential direction.

The reason for carrying out the scrub washing after the tape washing is that, as described above, if the glass substrate surfaces are rubbed in a direction other than the circumferential direction while a large amount of diamond slurry is still attached to the glass substrate member surfaces, then the texture shape may be destroyed.

Moreover, the reason for making the washing solution be at least one of a neutral aqueous solution and an alkaline aqueous solution is that if an acidic solution is used, then etching will not occur uniformly, i.e. the amount of etching will vary with the residual strain as discovered by the present inventors as described above, and hence the texture shape will change greatly. If tape washing and scrub washing are carried out in this order as described above, then the required washing quality can be obtained using a neutral or alkaline washing solution.

Furthermore, ultrasonic washing may be carried out after the scrub washing. By carrying out ultrasonic washing, foreign matter that is attached to the glass substrate member surfaces relatively weakly, for example general foreign matter other than abrasive grains such as shavings that has arisen during the tape washing step P8 and the scrub washing step P9, can be completely removed.

Moreover, for the reason given above, it is preferable to use at least one of a neutral aqueous solution and an alkaline aqueous solution as the washing solution in the ultrasonic washing.

As described above, in the present invention, after the texturing, washing is carried out using either or both of a neutral washing solution and an alkaline washing solution. Nevertheless, any substances commonly used in the washing of glass can be added to the washing solution(s), i.e. surfactants, chelating agents, organic solvents etc.

There are no particular limitations on the conditions in the ultrasonic washing such as the frequency and power output of the ultrasound, the washing time, and the washing temperature. Generally, however, to prevent damage and/or changing of the texture shape, the frequency of the ultrasound is set to not less than 38 kHz, the power output to not more than 1 W/cm², the washing time in a range of 2 to 20 minutes, and the washing temperature to not more than 70° C. After the ultrasonic washing, rinsing is carried out with pure water, and then drying is carried out. There are no particular limitations on the rinsing method; methods that can be used include immersion, immersion with application of ultrasound, showering, and jetting. There are also no particular limitations on the drying method; any method that is compatible with the kind of precision washing described above can be used, for example, spin drying or IPA drying.

### EXAMPLES

A description will now be given of examples of the present invention.

Preparing conditions and evaluation results for Examples 1 to 5 and Comparative Examples 1 to 3 are shown in Table 3.

TABLE 3

| | | | | | | | | | | Defects | |
|---|---|---|---|---|---|---|---|---|---|---|---|
| | | Washing After Texturing | | | | | | | Line | | Ridge-shaped |
| | Chemical | Tape Washing | | Scrub Washing | | | Ultrasonic Washing | | Density | | Abnormal Projections |
| | Strengthening | Carried | Washing | Carried | Washing | Sponge | Carried | Washing | No. | Asperity | (No. per 100 μm × |
| | Step | Out? | Solution | Out? | Solution | Material | Out? | Solution | per mm | Rmax (A) | 100 μm) |
| Example | | | | | | | | | | | |
| 1 | Before | Yes | pH10 | No | — | — | No | — | 8700 | 9.3 | 7.5 |
| | Texturing | | | | | | | | | | |
| 2 | Before | Yes | pH10 | Yes | pH10 | PVA | No | — | 8300 | 7.4 | 1.1 |
| | Texturing | | | | | | | | | | |
| 3 | Before | Yes | pH10 | Yes | pH10 | PVA | Yes | pH10 | 8300 | 6.1 | 1.1 |
| | Texturing | | | | | | | | | | |
| 4 | Before | Yes | pH10 | Yes | pH10 | PU | Yes | pH10 | 8200 | 5.9 | 0.0 |
| | Texturing | | | | | | | | | | |
| 5 | None | Yes | pH9 | Yes | pH10 | PVA | No | — | 7500 | 6.0 | 0.5 |
| Comparative | | | | | | | | | | | |
| Example | | | | | | | | | | | |
| 1 | After | Yes | pH10 | Yes | None | — | — | None | 3500 | 15.4 | 7.3 |
| | Texturing | | | | | | | | | | |
| 2 | After | Yes | pH4 | Yes | pH10 | PVA | Yes | pH10 | 350 | 7.3 | 0.3 |
| | Texturing | | | | | | | | | | |
| 3 | After | Yes | pH10 | Yes | pH4 | PVA | Yes | pH10 | 250 | 7.9 | 0.2 |
| | Texturing | | | | | | | | | | |

### Example 1

A donut-shaped aluminosilicate glass substrate member (6.0 mol % SiO₂, 11.0 mol % Al₂O₃, 8.0 mol % Li₂O, 9.1 mol % Na₂O, 2.4 mol % MgO, 3.6mol % CaO) of thickness 0.6 mm, outside diameter 65 mm and inside diameter 20 mm was subjected to chamfering, rough polishing, and smoothing polishing. The smoothing polishing was carried out using a both-surface polishing machine with polishing pads of Asker C hardness 70 and a polishing agent containing cerium oxide.

After the smoothing polishing, cerium oxide powder attached to the glass substrate member surfaces was removed through scrub washing using polyvinylalcohol sponges and ultrasonic washing using a strongly alkaline aqueous solution, and then rinsing was carried out with pure water. The glass substrate member was then dried for 1 minute in isopropyl alcohol vapor. The roughness of the glass substrate member surfaces was then evaluated using an AFM (atomic force microscope: Nanoscope made by Digital Instruments Inc.), whereupon it was found that Ra was 0.34 nm.

Next, the glass substrate member was immersed for 90 minutes in a mixed molten salt of potassium nitrate (60 wt %) and sodium nitrate (40 wt %) that had been heated to 380° C., thus carrying out chemical strengthening treatment in which lithium ions and sodium ions in the glass substrate member are replaced by potassium ions, which are larger in size than lithium ions and sodium ions. After the chemical strengthening treatment, the glass substrate member was immersed for 1 hour in warm water at 65° C., thus removing the molten salt.

Next, using a texturing machine (made by Exclusive Design Company, Inc.), texturing was carried out mechanically on the main surfaces of the glass substrate member using a diamond slurry and a tape while rotating the glass substrate member, under the conditions shown as “a” in Table 1. Then, using the same texturing machine, tape washing was carried out in which the main surfaces of the glass substrate member were rubbed in the circumferential direction under the conditions shown in Table 2 while feeding in an alkaline aqueous solution that had been adjusted to pH10, so as to remove the diamond slurry remained on the glass substrate member surface. The glass substrate member was then rinsed by immersing in a bath of pure water, and then, finally, isopropyl alcohol drying was carried out.

The surfaces of the substrate for magnetic disks substrate prepared as described above were observed using an AFM to evaluate the line density of the texture lines. As a result, it was found that a good texture with a line density of 8700 lines/mm had been formed, as shown under “Example 1” in Table 3. The evaluation was carried out by counting the number of undulations, i.e. ridges and troughs, recorded on the chart in a 5 μm×5 μm area. Here, a texture line on the glass substrate surface is only counted as such if the vertical distance (depth) between the recessed part that constitutes the texture line and at least one of the two projecting parts adjacent thereto in the radial direction is at least 7 angstroms, and the absolute value of the slope of a straight line in the radial direction joining the recessed part and the projecting part between which the vertical distance is at least 7 angstroms is at least 0.05. The line density is the number of such texture lines per μm.

Moreover, the asperity Rmax, which is the maximum projection height obtained by subtracting the minimum height in a 10 μm×10 μm area from the maximum height in this area, was 9.3 nm, and the number of ridge-shaped abnormal projections was 7.5 per 100 μm×100 μm.

### Example 2

The glass substrate of Example 2 was prepared as in Example 1, except that, after the tape washing, scrub washing was carried out in which the main surfaces of the glass substrate were rubbed in a direction crossing the circumferential direction while feeding in an alkaline aqueous solution that had been adjusted to pH10. The washing conditions during the scrub washing were a sponge pushing pressure of 10 g/cm², a rotational speed of 500 rpm, a washing solution dropping rate of 15 ml/min, and a washing time of 5 sec.

Regarding the shape of the texture on the surfaces of the substrate for magnetic disks prepared as described above, as shown under “Example 2” in Table 3, it was found that both the asperity and the number of ridge-shaped abnormal projections were greatly reduced compared with Example 1.

### Example 3

The glass substrate of Example 3 was prepared as in Example 2, except that, after the scrub washing, ultrasonic washing was carried out in an alkaline aqueous solution that had been adjusted to pH10. The frequency of the ultrasound was 45 kHz, the power output 300 W, and the washing time 3 min. Moreover, after the ultrasonic washing in the alkaline aqueous solution, rinsing was carried out with pure water, and then drying was carried out for 1 min in isopropyl alcohol vapor.

Regarding the shape of the texture on the substrate for magnetic disks prepared as described above, as shown under “Example 3” in Table 3, it was found that the asperity was reduced compared with Example 2.

### Example 4

The glass substrate of Example 4 was prepared as in Example 3, except that the material of the sponges used in the scrub washing was changed from a soft polyvinylalcohol to a polyurethane of Asker C hardness 45.

Regarding the shape of the texture on the substrate for magnetic disks prepared as described above, as shown under “Example 4” in Table 3, it was found that ridge-shaped abnormal projections were almost completely eliminated.

### Example 5

The glass substrate of Example 5 was prepared as in Example 2, except that the chemical strengthening treatment was not carried out, the tape washing was carried out on the main surfaces of the glass substrate member while feeding in an alkaline aqueous solution that had been adjusted to pH9, and then scrub washing was carried out on the main surfaces of the glass substrate member in a direction crossing the circumferential direction while feeding in an alkaline aqueous solution that had been adjusted to pH8.5. The scrub washing conditions were a sponge pushing pressure of 10 g/cm², a rotational speed of 500 rpm, a washing solution dropping rate of 15 ml/min, and a washing time of 5 sec.

Regarding the shape of the texture on the surfaces of the substrate for magnetic disks prepared as described above, as shown under “Example 5” in Table 3, it was found that the asperity was low, and that there were very few ridge-shaped abnormal projections.

### Comparative Example 1

The glass substrate of Comparative Example 1 was prepared as in Example 1, except that the chemical strengthening treatment was carried out after the texturing. Regarding the shape of the texture on the substrate for magnetic disks prepared, as shown under “Comparative Example 1” in Table 3, it was found that the line density was low at less than half of that for any of the examples described above, and hence the texture was insufficient.

### Comparative Examples 2 and 3

The glass substrates of Comparative Examples 2 and 3 were prepared as in Example 3, except that an acidic washing solution of pH4 was used in the tape washing (Comparative Example 2) or the scrub washing (Comparative Example 3). Regarding the shape of the texture on the substrates for magnetic disks prepared as described above, as shown under “Comparative Example 2” and “Comparative Example 3” in Table 3, it was found that the line density was very low, and hence the texture was insufficient.

Next, for Examples 6 to 9 and Comparative Examples 4 and 5, the smoothing polishing conditions and/or the texturing conditions were changed; the various conditions are shown in Table 4.

TABLE 4

| | Polishing Step | | | Average | | | | | | Defects | |
|---|---|---|---|---|---|---|---|---|---|---|---|
| | | | Hardness of | Roughness | Slurry | Texture Shape | | | | Ridge-shaped | |
| | Abrasive | Abrasive | Polishing Pads | Ra Before | Particle | Line | Line | | | Abnormal | |
| | Grains | Grains | (ASKER) | Texturing | Size | Density | Length | Ra | Rmax | Projections (No. | TOH |
| | 1 | 2 | C Hardness) | (nm) | (1 m) | (No. per mm) | (mm) | (A) | (A) | in Visual Field) | (nm) |
| Example | | | | | | | | | | | |
| 6 | Cerium Oxide | Not Carried | 70 | 0.45 | 0.2 | 5000 | 1.0 | 0.8 | 5.9 | 0 | |
| | | Out | | | | | | | | | |
| 7 | Cerium Oxide | Not Carried | 70 | 0.31 | 0.1 | 21000 | 1.7 | 0.5 | 5.9 | 0 | 4.7 |
| | | Out | | | | | | | | | |
| 8 | Cerium Oxide | Colloidal | 70 | 0.12 | 0.1 | 35000 | 3.5 | 0.4 | 5.9 | 0 | — |
| | | Silica | | | | | | | | | |
| 9 | Cerium Oxide | Not Carrried | 75 | 0.24 | 0.1 | 21000 | 1.7 | 0.5 | 5.9 | 0 | 3.5 |
| | | Out | | | | | | | | | |
| Com- | | | | | | | | | | | |
| parative | | | | | | | | | | | |
| Example | | | | | | | | | | | |
| 4 | Cerium Oxide | Not Carried | 70 | — | — | — | — | — | — | — | 6.1 |
| | | Out | | | | | | | | | |
| 5 | Cerium Oxide | Not Carried | 75 | — | — | — | — | — | — | — | 4.5 |
| | | Out | | | | | | | | | |

### Example 6

The glass substrate of Example 6 was prepared as in Example 1, except that the smoothing polishing conditions were changed to make the surface roughness Ra after the smoothing polishing 0.45 nm. The texture line density for the substrate for magnetic disks prepared as described above was slightly lower than for the other examples described earlier.

### Example 7

The glass substrate of Example 7 was prepared as in Example 1, except that the texturing conditions were made to be those shown as “b” in Table 1. By changing the particle size of the diamond slurry, it was possible to markedly increase the line density of the texture. Moreover, making the surface roughness Ra be 0.31 nm after the smoothing polishing also had a contribution; if the Ra value exceeds 0.4 nm, then the texture lines are divided into parts, and hence it becomes difficult to improve the magnetic properties.

Moreover, the TOH (take-off height), which is an indicator of the head flight stability, was measured to be 4.7 nm. The method of measuring the TOH is to gradually reduce the rotational speed of the substrate for magnetic disks and hence reduce the head flying height, and at the same time detect the signal from the piezo mounted on the head; the TOH is then the head flying height at the threshold where the signal output from the piezo suddenly rises. A lower value of the TOH means that the head can fly stably even at a lower flying height.

### Example 8

The glass substrate of Example 8 was prepared as in Example 7, except that after carrying out the smoothing polishing using cerium oxide, both-surface polishing was carried out using colloidal silica. The surface roughness Ra of the substrate for magnetic disks prepared as described above after the both-surface polishing was 0.12 nm. It was found that the texture line density of the prepared substrate for magnetic disks was extremely high at 35000 lines/mm, and moreover that the average line length was high.

### Example 9

The glass substrate of Example 9 was prepared as in Example 7, except that the polishing pads used in the smoothing polishing were made to be polishing pads having an Asker C hardness of 75.

The TOH of the substrate for magnetic disks prepared as described above was measured to be 3.5 nm, and hence it was found that extremely good flight properties could be obtained.

### Comparative Examples 4 and 5

The glass substrate of Comparative Example 4 was prepared as in Example 7, except that the texturing was not carried out. Moreover, the glass substrate of Comparative Example 5 was prepared as in Comparative Example 4, except that polishing pads having an Asker C hardness of 75 were used in the smoothing polishing. The TOH of the substrate for magnetic disks prepared as described above was 6.1 nm for Comparative Example 4 and 4.5 nm for Comparative Example 5. Comparing the results for Examples 7 and 9 and Comparative Examples 4 and 5, it can be seen that the excellent flight properties obtained in Example 9 were due to the combination of the hard polishing pads and the circumferential direction texture.

What is claimed is:

1. A method of manufacturing a glass substrate for magnetic disks, comprising:
a texturing step of using a tape while feeding a diamond slurry onto at least one main surface of a glass substrate member that has been processed into a substantially circular shape, thus forming a linear texture in a circumferential direction on the at least one main surface; and
a chemical strengthening step of chemically strengthening a mechanical strength of the glass substrate member to a level required of the glass substrate for magnetic disks;
wherein said texturing step is carried out after said chemical strengthening step.

2. A method of manufacturing a glass substrate for magnetic disks as claimed in claim 1, further comprising, following said texturing step, a tape washing step of rubbing the at least one main surface of the glass substrate member in the circumferential direction using the tape while feeding at least one of a neutral aqueous solution and an alkaline aqueous solution onto the at least one main surface, and a scrub washing step of rubbing the at least one main surface using at least one scrubbing member while feeding at least one of a neutral aqueous solution and an alkaline aqueous solution onto the at least one main surface.

3. A method of manufacturing a glass substrate for magnetic disks as claimed in claim 2, wherein in said scrub washing step, the rubbing of the at least one main surface of the glass substrate member is carried out in a direction crossing the circumferential direction.

4. A method of manufacturing a glass substrate for magnetic disks as claimed in claim 2 or 3, further comprising, following said scrub washing step, an ultrasonic washing step of washing the at least one main surface of the glass substrate member by applying ultrasound to the at least one main surface while feeding at least one of a neutral aqueous solution and an alkaline aqueous solution onto the at least one main surface.

5. A method of manufacturing a glass substrate for magnetic disks as claimed in claim 2 or 3, wherein the at least one scrubbing member comprises a sponge having an Asker C hardness of not less than 40.

6. A method of manufacturing a glass substrate for magnetic disks as claimed in any of claims 1 through 3, further comprising, before said texturing step, a smoothing polishing step of polishing the at least one main surface of the glass substrate member using at least one polishing member to make the at least one main surface smooth, wherein said smoothing polishing step makes the at least one main surface have an average roughness Ra of not more than 0.35 nm as measured using an atomic force microscope.

7. A method of manufacturing a glass substrate for magnetic disks as claimed in any of claims 1 through 3, further comprising, before said texturing step, a smoothing polishing step of polishing the at least one main surface of the glass substrate member using at least one polishing member to make the at least one main surface smooth, wherein said smoothing polishing step makes the at least one main surface have an average roughness Ra of not more than 0.25 nm as measured using an atomic force microscope.

8. A method of manufacturing a glass substrate for magnetic disks as claimed in claim 7, wherein said smoothing polishing step comprises polishing the at least one main surface of the glass substrate member while feeding a slurry containing cerium oxide onto the at least one main surface, and then polishing the at least one main surface while feeding colloidal silica onto the at least one main surface.

9. A method of manufacturing a glass substrate for magnetic disks as claimed in claim 8, wherein said smoothing polishing step makes the at least one main surface of the glass substrate member having a waviness of a wavelength in a range of 0.2 to 1.4 mm have an average roughness Ra of not more than 0.25 nm as measured using a non-contact optical interferometer.

10. A method of manufacturing a glass substrate for magnetic disks as claimed in claim 9, wherein the at least one polishing member comprises a suede pad having an Asker C hardness of not less than 73.

11. A method of manufacturing a glass substrate for magnetic disks, comprising:
a texturing step of using a tape while feeding a diamond slurry onto at least one main surface of a glass substrate member that has been processed into a substantially circular shape, thus forming a linear texture on the at least one main surface;
wherein in said texturing step the texture is formed in a circumferential direction of the at least one main surface of the glass substrate member.

12. A method of manufacturing a glass substrate for magnetic disks as claimed in claim 11, further comprising, following said texturing step, a tape washing step of rubbing the at least one main surface of the glass substrate member in the circumferential direction using the tape while feeding at least one of a neutral aqueous solution and an alkaline aqueous solution onto the at least one main surface, and a scrub washing step of rubbing the at least one main surface of the glass substrate member in a direction crossing the circumferential direction using at least one scrubbing member while feeding at least one of a neutral aqueous solution and an alkaline aqueous solution onto the at least one main surface.

13. A method of manufacturing a glass substrate for magnetic disks as claimed in claim 12, further comprising, following said scrub washing step, an ultrasonic washing step of washing the at least one main surface of the glass substrate member by applying ultrasound to the at least one main surface while feeding at least one of a neutral aqueous solution and an alkaline aqueous solution onto the at least one main surface.

14. A method of manufacturing a glass substrate for magnetic disks as claimed in claim 12 or 13, wherein the at least one scrubbing member comprises a sponge having an Asker C hardness of not less than 40.

15. A method of manufacturing a glass substrate for magnetic disks as claimed in any of claims 11 through 13, further comprising, before said texturing step, a smoothing polishing step of polishing the at least one main surface of the glass substrate member using at least one polishing member to make the at least one main surface smooth, wherein said smoothing polishing step makes the at least one main surface have an average roughness Ra of not more than 0.35 nm as measured using an atomic force microscope.

16. A method of manufacturing a glass substrate for magnetic disks as claimed in any of claims 11 through 13, further comprising, before said texturing step, a smoothing polishing step of polishing the at least one main surface of the glass substrate member using at least one polishing member to make the at least one main surface smooth, wherein said smoothing polishing step makes the at least one main surface have an average roughness Ra of not more than 0.25 nm as measured using an atomic force microscope.

17. A method of manufacturing a glass substrate for magnetic disks as claimed in claim 16, wherein said smoothing polishing step comprises polishing the at least one main surface of the glass substrate member while feeding a slurry containing cerium oxide onto the at least one main surface, and then polishing the at least one main surface while feeding colloidal silica onto the at least one main surface.

18. A method of manufacturing a glass substrate for magnetic disks as claimed in claim 15, wherein said smoothing polishing step makes the at least one main surface of the glass substrate member having a waviness of a wavelength in a range of 0.2 to 1.4 mm have an average roughness Ra of not more than 0.25 nm as measured using a non-contact optical interferometer.

19. A method of manufacturing a glass substrate for magnetic disks as claimed in claim 18, wherein the at least one polishing member comprises a suede pad having an Asker C hardness of not less than 73.

20. A glass substrate for magnetic disks, manufactured using a method of manufacturing a glass substrate for magnetic disks as claimed in any of claims 1 through 19, comprising:
a linear texture formed on at least one main surface of the glass substrate;
wherein the linear texture has a line density in a range of 5000 to 40000 lines/mm as measured using an atomic force microscope, an average roughness Ra in a range of 0.2 to 0.9 nm, and a value Rmax obtained by subtracting a minimum height of said texture from a maximum height of said texture of not more than 10 nm.

21. A glass substrate for magnetic disks as claimed in claim 20, wherein the linear texture has an average line length of not less than 0.3 mm.
